(19) United States
(12) Patent Application Publication
(10) Pub. No.: US 2004/0166284 A1
(43) Pub. Date: Aug. 26, 2004

(54) Ceramic packing element for mass transfer applications

(75) Inventors: Hassan S. Niknafs, Stow, OH (US); Robert L. Miller, Stow, OH (US)

Correspondence Address: Ann M. Skerry, Esq., Fay, Sharpe, Fagan, Minnich & McKee, LLP, 1100 Superior Avenue, Seventh Floor, Cleveland, OH, 44114-2518, US

(73) Assignee: Saint-Gobain Ceramics & Plastics, Inc.

(21) Appl. No.: 10/761,559

(22) Filed: Jan. 21, 2004

Related U.S. Application Data
(63) Continuation-in-part of application No. 10/087,564, filed on Feb. 28, 2002, now Pat. No. 6,699,562.
(63) Continuation-in-part of application No. 10/136,478, filed on May 1, 2002.
(60) Provisional application No. 60/498,150, filed on Aug. 27, 2003.

(30) Foreign Application Priority Data
Feb. 28, 2003 (WO) PCT/US03/06263

(51) Int. Cl. B32B 3/12

(52) U.S. Cl. 428/116

(57) ABSTRACT

A ceramic packing element (10) has an essentially cylindrical structure (12) with a plane of symmetry in a direction defining a length (L) of the element and a greatest dimension (D) perpendicular to the length defining a diameter of the element. The element has a plurality of internal septa (16) defining a plurality of passages (18) through the element. The element has an open face area which is from 40-80%.

This application claims the benefit as a Continuation-in-Part of U.S. application Ser. No. 10/087,564, filed on Feb. 28, 2002, and U.S. application Ser. No. 10/136,478, filed on May 1, 2002, and claims the benefit of PCT Application PCT/US03/06263, filed on Feb. 28, 2003, and U.S. Provisional Application Serial No. 60/498,150, filed on Aug. 27, 2003, the disclosures of which are incorporated herein in their entireties by reference.

### BACKGROUND OF THE INVENTION

1. Field of the Invention

The invention relates to packing elements of the type that are often called “random” or “dumped” packings. In particular, it relates to a packing element having a plurality of through passages for promoting fluid flow, and will be described with particular reference thereto.

2. Discussion of the Art

Random or dumped packings are used to fill tower units in which mass or heat transfer processes occur. A particularly important application is the use of such ceramic elements in mass transfer applications, such as the removal of sulfur dioxide from waste gases flowing through a tower. An important factor in maximizing efficiency is the maintenance of as low a pressure difference between top and bottom of the tower as possible (termed the “pressure drop”). To ensure this, the packing elements should present the minimum resistance to flow. This is promoted by very open structures. However, gains made in reduced resistance to flow are often offset by a loss in mass transfer efficiency in between two fluid phases passing through the packing elements. Additionally, open structure tends to cause the elements in the tower to nest together, such that parts of one packing element penetrate within the space of a second element. It is therefore important that the design of the elements minimize the tendency of the elements to nest together.

Another application is in heat recovery operations where it is desirable to provide maximum effective contact with hot fluids passing through a reactor.

Ceramic packing elements can be produced by an extrusion or a dry-pressing process and hence have an essentially uniform cross-section along one axial direction which provides an axis of symmetry for the element. Several such shapes have been described in the art ranging from the very simple to the complex. All are based on an essentially cylindrical shape and differ primarily in the internal structure within the cylindrical shape. The simplest structure is a basic cylinder with no internal structure at all. This type of structure is often called a Raschig ring and has been known for many years. Wagon-wheel shapes having internal structure are described in U.S. Pat. Nos. 3,907,710 and 4,510,263. Other convoluted shapes have been proposed, such as those described in U.S. Pat. No. 5,747,143. More complex structures are described in U.S. Design Pat. No. 445,029 and U.S. Pat. No. 6,007,915. Typically, the structures used are about 8 cm, or less, in their maximum dimension.

The present invention provides a new and improved ceramic packing element and method of use which overcome the above-referenced problems and others.

### SUMMARY OF THE INVENTION

In accordance with one aspect of the present invention, a ceramic packing element is provided. The packing element includes an essentially cylindrical structure comprising a length and a greatest dimension perpendicular to the length defining the diameter of the element. The element is provided with a plurality of internal septa which intersect to define a plurality passages. The element defines first and second faces, each of the faces having an open face area of from 40-80%.

In accordance with another aspect of the present invention, a ceramic packing element is provided. The packing element includes an essentially cylindrical structure comprising a length and a greatest dimension perpendicular to the length defining the diameter of the element. The diameter is at least 10 cm. A plurality of internal septa intersect to define a plurality passages through the element, the septa having a thickness of from 0.12 to 0.8 cm.

The advantages of the present invention will be readily apparent to those skilled in the art, upon a reading of the following disclosure and a review of the accompanying drawings.

### BRIEF DESCRIPTION OF THE DRAWINGS

The invention may take form in various components and arrangements of components, and in various steps and arrangements of steps. The drawings are only for purposes of illustrating a preferred embodiment and are not to be construed as limiting the invention.

FIG. 1 is a top plan view of a packing element according to the present invention;

FIG. 2 is a side view of the packing element of FIG. 1;

FIG. 3 is a perspective view of the packing element of FIG. 1;

FIG. 4 is a computer generated plot of predicted pressure drop penalties at equal mass transfer efficiency for a bed formed from the present packing compared with four conventional packing elements; and

FIG. 5 is a plot of the relative efficiency of a bed formed from the present packing compared with four conventional packing elements.

### DETAILED DESCRIPTION OF THE PREFERRED EMBODIMENT

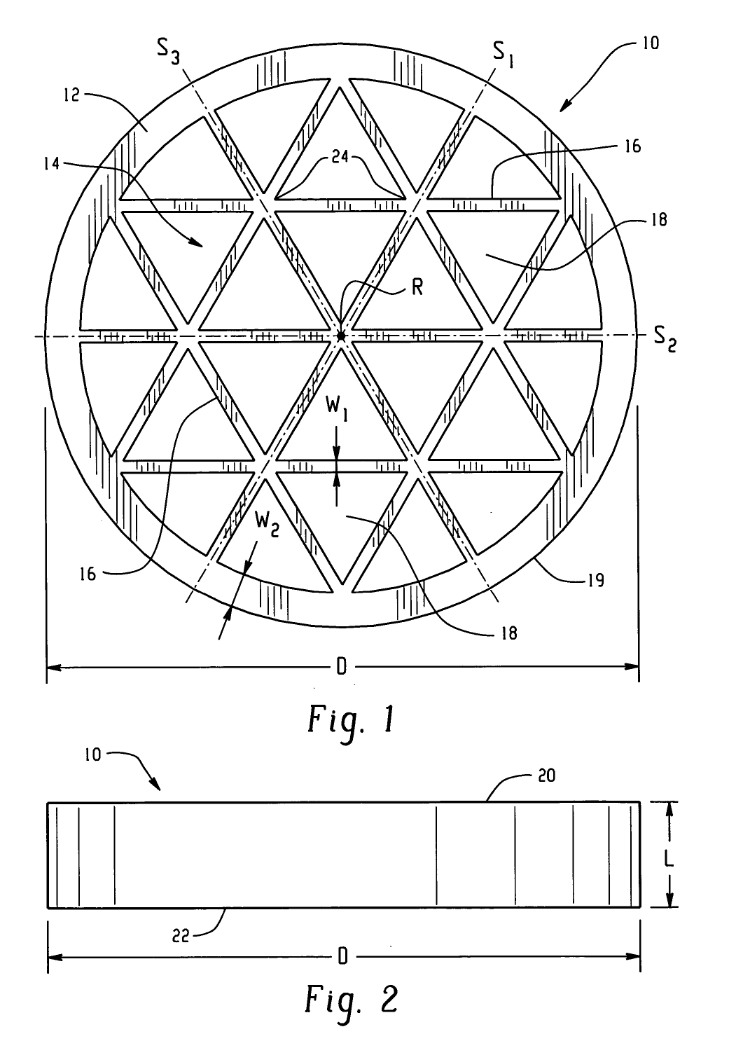

With reference to FIG. 1, a ceramic packing element 10 includes a peripheral containing structure 12 which defines an interior space 14. A plurality of ribs or septa 16 divide the interior space 14 into a plurality of through passages or channels 18.

The containing structure 12 is essentially cylindrical in shape and this is understood to include perfect cylinders and shapes in which a round cylindrical shape has been somewhat flattened to create an oval cross-section as well as regular and irregular polygonal shapes with at least five sides. The containing structure 12 in FIG. 1 is cylindrical, with a smooth outer surface 19, although it is contemplated that it may alternatively have a ridged or other outer surface.

In the context of this invention the term “septum” (plural “septa”) is used to describe a structural member connecting one interior part of the cylindrical containing structure with another part and/or with another septa. It therefore includes structures with lengths up to and including a diameter or maximum dimension of the element. In the illustrated embodiment, each of the septa 16 defines a chord which connects with the containing structure 12 at first and second ends thereof.

With reference also to FIG. 2, the element 10 has at least one plane of symmetry S, parallel with a length L of the element, which passes through a central axis of rotation R. Three planes of symmetry S₁, S₂, S₃ are shown in the illustrated embodiment. By central axis of rotation, it is meant that the element can be rotated about its central axis through an angle of 360/(number of planes of symmetry) to an identical conformation. For FIG. 1, the angle is thus 120°.

The through passages or channels 18 illustrated in FIG. 1 are generally of uniform shape. Specifically, those passages defined only by septa have a uniform size of triangular shape, while those passages defined in part by the containing structure 12 are shaped to accommodate the curved shape of the containing structure. It is also contemplated that a few of the channels may be larger than the rest of the channels, to provide enhanced flow through the element. For example, the enlarged channels may be formed by combining two or more of the triangular channels.

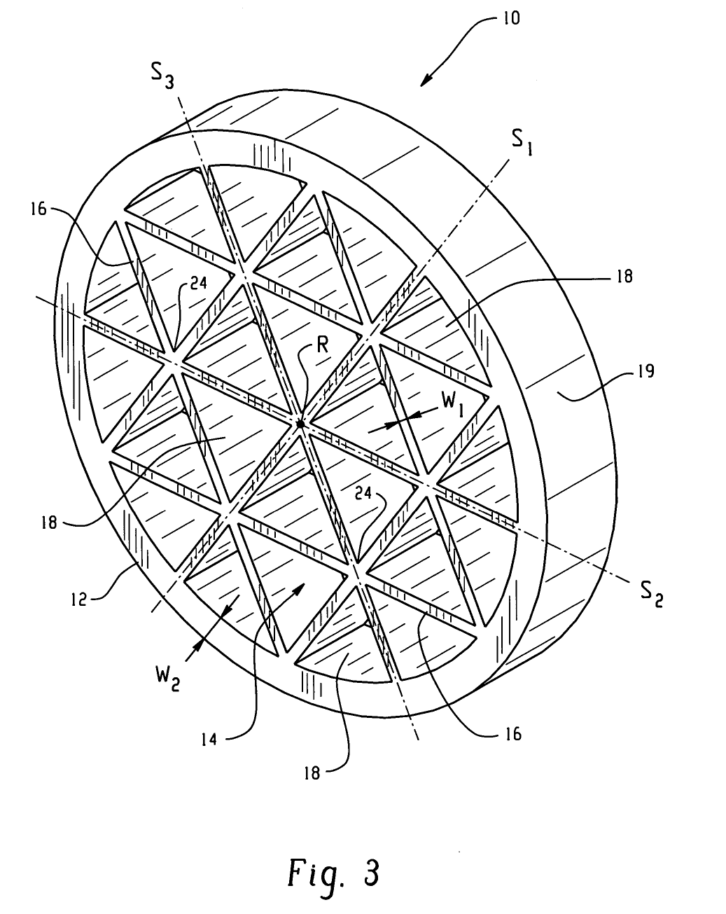

The element 10 of FIGS. 1-3 can have a length L, along the axis of rotation R, and a greatest dimension D, perpendicular to the axis of rotation, which defines the diameter of the packing element. The cross section of the packing element is consistent along the length of the element. The ratio of D:L can be from about 1 to about 15, in one embodiment, from 2.7 to 6, and in another embodiment, about 4.0 to 6.0. In the Drawings the ratio of D:L is about 4.6. Where the structure is extruded, the axis of symmetry R may be in the direction of extrusion of the structure.

In one embodiment, the packing element has a diameter D of at least 10 cm, in another embodiment, D is at least at least 12 cm. The packing element can have a diameter of up to about 20 cm, more preferably, less than about 16 cm. In one specific embodiment, the diameter D is about 14 cm. Below a diameter D of about 10 cm, the pressure drop across the bed tends to increase unless the septa and/or peripheral structure are correspondingly reduced in thickness. However, there is a limit on the minimum septa thickness which can be readily manufactured by an extrusion process.

The larger packing element achieves a lower pressure drop across a packing element bed. However, enlargement in the size of conventional packing elements results in a drop in efficiency of the bed. It has unexpectedly been found that packing element properties, such as pressure drop and relative efficiency, can be maintained in desirable ranges, even for these large sizes, by carefully controlling the face area of the packing element. As shown in FIG. 2, the element defines upper and lower exposed faces 20, 22, respectively, which extend generally perpendicular to the length L. “Face area” is defined as the area of the exposed face occupied by the packing element, expressed as a percentage of a total area of the face. For the embodiment of FIG. 1, the total area is π(D/2)². The face area and, by subtraction of the face area from 100%, the “open face area”, affect two important parameters of the packing element, namely the pressure drop across a bed of packing elements and the efficiency of the bed. Efficiency is a measure of the mass transfer rate (or thermal energy) recovered by the packing element and can be expressed as a ratio of that of a comparative packing element. The pressure drop across the bed can be compared by determining the pressure drop for equal mass transfer efficiency.

The open face area can be from about 40-80%. In one embodiment, the open face area is at least 45%, in another embodiment, at least 50%. In one embodiment, the open face area up to 70%, in another embodiment up to 65%, and in yet another embodiment, up to 60%. In one specific embodiment, the open face area is about 55%. For open face areas in this range, it has been found that the packing element can compare very favorably with commercial packing elements of similar size, and can perform better than much smaller packing elements, such as conventional saddle-shaped packing elements of only about ⅗ the maximum dimension.

Where formed in an extrusion process which results in slight variations in face area between formed packing elements, the average open face area of pacing elements in a bed of the packing elements can be in the range of 45-65%.

It will be appreciated that the face area depends on the width W₁ of the septa 16 and the number of septa. It has been found that if the septa are too narrow, the packing element tends to become crushed in the bed. For example, for a ceramic packing element of about 14 cm, the septa can have a width W₁ of at least 0.12 cm, in one embodiment, at least 0.2 cm, and in one specific embodiment, about 0.3 cm. The septa width W₁ can be up to about 0.8 cm, in one embodiment, less than about 0.5 cm. The perimeter wall 10 can have a width W₂ of at least 0.12 cm, in one embodiment, at least 0.2 cm, and in one specific embodiment, about 0.3 cm. The wall width W₂ can be up to about 1.4 cm, in one embodiment, less than about 1 cm.

The ratio of the septa width W₁ to the diameter D can be from about 0.01 to about 0.03. In one embodiment, W₁/D is from about 0.015-0.027.

In one embodiment, illustrated in FIG. 1, there are nine septa, arranged in sets of three, which are angularly spaced from each of the other sets by 120°. It will be appreciated, however, that greater of fewer numbers of septa can be employed, depending on the size of the packing element. The septa intersect other septa at points of intersection 24. Preferably, the distance between two adjacent points of intersection 24 is less than about 4 cm, more preferably, about 3.0-3.5 cm.

The length L of the packing element can be from about 0.4 cm to about 10 cm. In one embodiment, L is from 1 to 6 cm. In one specific embodiment, L is about 3 cm.

The ceramic elements 10 can be formed from any suitable ceramic material such natural or synthetic clays, zeolites, cordierites, aluminas, zirconia, silica, or mixtures of these. The formulation can be mixed with bonding agents, extrusion aids, pore formers, lubricants and the like to assist in the extrusion process and/or to generate the desired porosity or surface area for the intended application.

Where the ceramic packing elements are produced by an extrusion or a dry-pressing process, they can have an essentially uniform cross-section along one axial direction which provides an axis of radial symmetry for the element or a plane of symmetry.

The elements 10 can be used in mass and heat transfer applications or as bases upon which catalytic components are deposited. Mass transfer applications include the transfer of mass in the form of one or more components between first and second fluids, which may be both liquids or a liquid and a gas. The ceramic elements act as a provider of a wetted surface for the liquid phase, facilitating the transfer of components between the fluids. Exemplary mass transfer applications include the removal of gas components, such as sulfur dioxide, from a flowing gas stream. An important mass transfer application of the ceramic elements is in sulfuric acid plant absorbers.

For example, the elements 10 can be packed into a tower or column to form a bed of packing elements. The column may be horizontally or vertically orientated.

Exemplary heat transfer applications involve heat recovery from streams of hot gases. An example of such an application is found in thermal regenerators attached to plants whose function is to burn off any combustible material from a waste gas stream. In such regenerators it is important for efficient operation that the heat values from the exhaust gas stream be used to heat up the incoming waste gas to be treated so as to minimize the cost of fuel required to burn off the combustible material.

The elements can however be used with advantage in any application in which the surface area is an important factor in determining the efficiency with which the elements perform their assigned task.

Without intending to limit the scope of the invention, the following Example demonstrates the effectiveness of the ceramic packing element.

### EXAMPLE

Theoretical calculations were made for a bed formed from ceramic packing elements formed according to FIG. 1. The elements had a diameter D of 14 cm, a wall thickness W₂ of 0.6 cm, a septa width W₁ of 0.3 cm, and a length L of 3 cm.

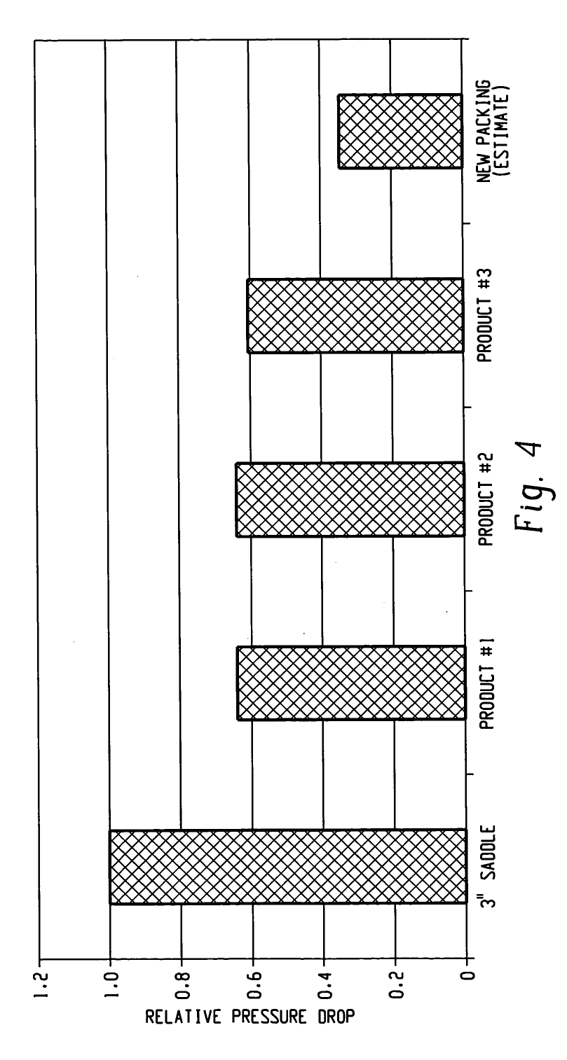

FIG. 4 shows the theoretically determined relative pressure drop of a bed of the packing elements as compared with an equivalent bed formed from saddle-shaped packing elements having a largest dimension of 7.6 cm. The pressure drop is determined for beds of equal mass transfer efficiency, with the saddle shaped packing element assigned a relative pressure drop of 1. The results are also compared for three beds formed from commercial products, labeled products 1, 2, and 3. Product 1 is a wave-shaped packing element with three holes and overall dimensions of approximately 5 cm×7.6 cm×20.3 cm. Product 2 is a modified saddle shape with through holes sold under the tradename Cecebe HP™ Porcelain Saddle Packing from Noram-Cecebe, Vancouver, BC Canada. Product 3 is packing element with a multi-layered structure available as Flexeramic® structured packing systems from Koch Knight LLC, East Canton, Ohio.

The saddle and commercial packing element beds all have a pressure drop penalty which is higher than the bed formed from the packing elements of FIG. 1, indicating the superiority of the present packing element for maintaining flow through the bed.

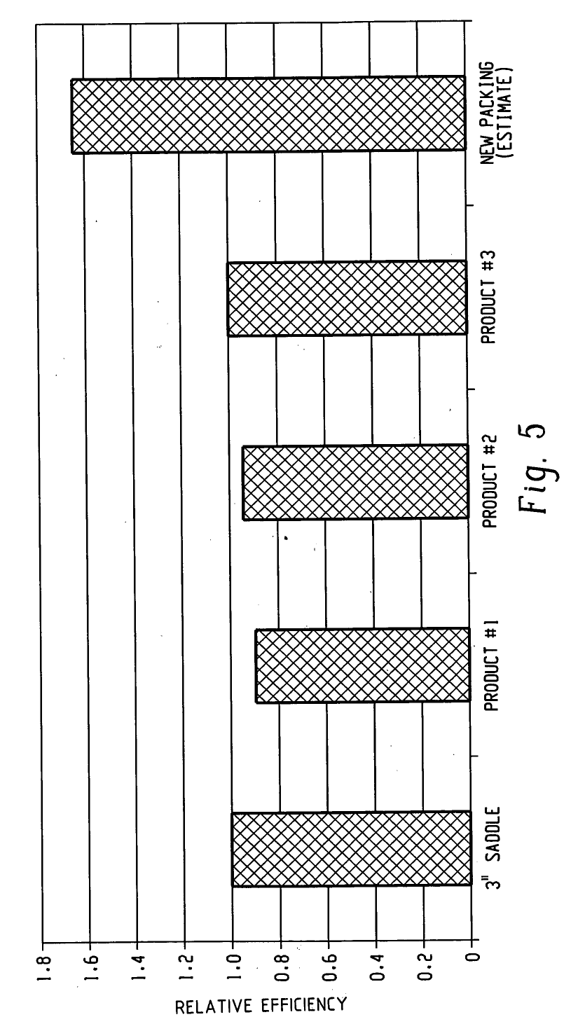

It is generally expected that a packing element which provides greater flow will suffer from a concomitant loss in efficiency. However, the results shown in FIG. 5 demonstrate the superior mass transfer efficiency of the present packing element, as compared with the saddle and three commercial products.

The invention has been described with reference to the preferred embodiment. Obviously, modifications and alterations will occur to others upon reading and understanding the preceding detailed description. It is intended that the invention be construed as including all such modifications and alterations insofar as they come within the scope of the appended claims or the equivalents thereof.

Having thus described the preferred embodiments, the invention is now claimed to be:

1. A ceramic packing element comprising:
an essentially cylindrical structure comprising a length and a greatest dimension perpendicular to the length defining the diameter of the element, the element being provided with a plurality of internal septa which intersect to define a plurality passages, the element defining first and second faces, each of the faces having an open face area of from 40-80%.

2. The ceramic packing element according to claim 1, wherein the open face area is from 45-65%.

3. The ceramic packing element according to claim 2, wherein the open face area is from 50-60%.

4. The ceramic packing element according to claim 1, wherein the essentially cylindrical structure comprises a plane of symmetry in a direction defining the length of the element.

5. The ceramic packing element according to claim 1, wherein a ratio of the diameter to the length is from 2.7 to 6.0.

6. The ceramic packing element according to claim 5, wherein the ratio of the diameter to the length is from 4.0 to 6.0.

7. The ceramic packing element according to claim 6, wherein the ratio of the diameter to the length is from 4.5 to 5.0.

8. The ceramic packing element according to claim 1, comprising at least twenty of the passages.

9. The ceramic packing element according to claim 1, wherein at least some of the passages have a triangular cross-section.

10. The ceramic packing element according to claim 1, wherein the greatest dimension is at least 10 cm.

11. The ceramic packing element according to claim 10, wherein the greatest dimension is from 12-20 cm.

12. The ceramic packing element according to claim 1, wherein the septa have a thickness, parallel with the first face, of at least 0.12 cm.

13. The ceramic packing element according to claim 12, wherein the septa thickness is from 0.2-0.5 cm.

14. The ceramic packing element according to claim 12, wherein a ratio of the septa thickness to the diameter is from about 0.01 to about 0.03.

15. The ceramic packing element according to claim 1, wherein the structure has a thickness, parallel with the first face, of at least 0.12 cm.

16. The ceramic packing element according to claim 1, wherein all of the septa in the packing element comprise first and second ends, the septa being connected with the cylindrical structure adjacent the first and second ends.

17. The ceramic packing element according to claim 1, wherein the ceramic is made from a material selected from the group consisting of natural clays, synthetic clays, aluminas, zeolites, cordierite, zirconia, silica, and mixtures thereof.

18. A method of performing at least one of transferring heat to or from a fluid stream and transferring mass between fluid phases, the method comprising:
flowing the fluid stream through a bed comprising the ceramic packing elements of claim 1, the packing elements performing at least one of transferring the heat and providing a surface at which the transfer of mass takes place between the fluid phases.

19. The method of mass transfer according to claim 18, wherein transferring mass includes transferring gaseous sulfur compounds between the fluid phases.

20. A ceramic packing element comprising:
an essentially cylindrical structure comprising a length and a greatest dimension perpendicular to the length defining the diameter of the element, the diameter being at least 10 cm; and
a plurality of internal septa which intersect to define a plurality passages through the element, the septa having a thickness of from 0.12 to 0.8 cm.
